(19) United States
(12) Patent Application Publication
(10) Pub. No.: US 2004/0175482 A1
(43) Pub. Date: Sep. 9, 2004

(54) Choline-fortified cereal and method

(75) Inventors: Joseph N. Casey, Fort Wayne, IN (US); Paul J. Whalen, Rapid City, SD (US)

Correspondence Address: JAMES L. CORDEK, P. O. Box 88940, St. Louis, MO, 63188, US

(73) Assignee: Solae, LLC, St. Louis, MO

(21) Appl. No.: 10/790,152

(22) Filed: Mar. 1, 2004

Related U.S. Application Data
(60) Provisional application No. 60/452,250, filed on Mar. 5, 2003.

(51) Int. Cl. A23K 1/175

(52) U.S. Cl. 426/620

(57) ABSTRACT

A method for producing a choline-fortified, ready-to-eat cereal including the steps of cooking a blend of cereal ingredients to produce a cooked cereal mass; and blending a source of choline into the cooked cereal mass to produce a choline-fortified cereal mass used in the production of the ready-to-eat cereal. The source of choline may be lecithin and/or a choline salt. The step of blending a source of choline into the cooked cereal mass may include blending the choline source into the cooked cereal mass in an amount supplying at least 5% of the Adequate Intake (AI) of choline per serving of the choline-fortified, ready-to-eat cereal. A composition including a ready-to-eat cereal, the ready-to-eat cereal including a cereal grain and a nutritionally significant amount of choline. The nutritionally significant amount of choline is an amount supplying at least 5% of the AI of choline per serving of the composition.

### PRIORITY REFERENCE

This application claims the benefit of priority under 35 U.S.C. §119(e) to provisional application No. 60/452,250, filed Mar. 5, 2003.

### BACKGROUND OF THE INVENTION

1. Field of the Invention

The present invention relates to ready-to-eat breakfast cereals, and more particularly to fortified ready-to-eat breakfast cereals.

2. Description of the Related Art.

Ready-to-eat breakfast cereals are popular and versatile food items. Consumers commonly eat ready-to-eat breakfast cereals plain or in a bowl with milk, juice or other fluid. Ready-to-eat breakfast cereals are formulated primarily of one or more cereal grains, such as corn, wheat, rice and barley and may include other ingredients such as sugar, malt syrup, calcium carbonate, salt, corn syrup, a vitamin, and/or a mineral. Ready-to-eat breakfast cereals are available in a variety of different forms and textures including flaked cereal, puffed cereal, and shredded cereal; each providing consumers with a different mouthfeel and bowl-life (i.e. the length of time the cereal maintains its texture in a bowl with milk, juice, or other fluid). Ready-to-eat breakfast cereals also provide a good source of nutrition and some are fortified with certain vitamins and minerals, such as Vitamin B₁, Vitamin C, Vitamin B₆, folic acid and/or Vitamin E to increase their nutritional value.

Choline is believed to be important in the normal functioning of the liver, the maintenance of cell membrane integrity, and the movement of fats across the cell membrane. Choline is also a component of the neurotransmitter acetylcholine, and is believed to be essential for normal brain functioning. It has been determined that the Adequate Intake (AI) for choline is 550 mg per day for adult males, and 425 mg per day for adult females. See Dietary Reference Intakes For Thiamin, Riboflavin, Niacin, Vitamin B⁶, Foliate, Vitamin B ², Pantothenic Acid, Biotin, and Choline, Food and Nutrition Board, Institute of Medicine (IOM), NAS, 1998, p. 390.

Unfortunately, the popular ready-to-eat breakfast cereals have not been fortified with choline because past attempts at fortifying ready-to-eat breakfast cereals with choline have produced an unacceptable food product. More specifically, attempts have been made to produce a choline-fortified, ready-to-eat breakfast cereal by adding a source of choline to the raw cereal ingredients at the beginning of the extrusion process, before cooking the cereal ingredients. However, the added choline interferes with the cook stage of the extrusion process, thereby resulting in an extrusion product lacking the elasticity needed to form acceptable flakes. Ultimately, the resulting cereal flakes have an undesirable texture, flavor, appearance, and bowl life. Therefore, a need remains for a choline-fortified, ready-to-eat breakfast cereal and a method for producing the same.

### SUMMARY OF THE INVENTION

The present invention provides a method for producing a choline-fortified, ready-to-eat cereal. The method, in one form, includes the steps of cooking a blend of cereal ingredients by introducing the blend of cereal ingredients into a cook zone of an extruder to produce a cooked cereal mass; and blending a source of choline into the cooked cereal mass in a mixing zone of the extruder to produce a choline-fortified cereal mass used in the production of the ready-to-eat cereal.

In a related aspect of the present invention, the blend of cereal ingredients includes a cereal grain selected from the group consisting of corn, wheat, rye, rice, oats, barley and mixtures thereof. The blend of cereal ingredients may further include an ingredient selected from the group consisting of sugar, malt syrup, cocoa powder, milk powder, brown sugar, corn starch, calcium carbonate, salt, corn syrup, a vitamin, a mineral, and mixtures thereof.

In another related aspect of the present invention, the method for producing a choline-fortified, ready-to-eat cereal may also include the step of conditioning the blend of cereal ingredients in a conditioning cylinder prior to the step of cooking the cereal. The method may also include the steps of extruding the choline-fortified cereal mass; and cutting the extruded choline-fortified cereal mass into choline-fortified cereal pellets.

The method for producing a choline-fortified, ready-to-eat cereal may further include the step of flaking the choline-fortified cereal pellets to produce choline-fortified cereal flakes. Alternatively, the method for producing a choline-fortified, ready-to-eat cereal further includes the step of puffing the cereal pellets to produce choline-fortified cereal puffs found in the choline-fortified, ready-to-eat cereal.

In another related aspect of the present invention, the source of choline is lecithin. The lecithin is blended into the cooked cereal mass in an amount to supply at least 5% of the Adequate Intake (AI) of choline per serving of the choline-fortified, ready-to-eat cereal.

In another form, the method includes the steps of cooking a blend of cereal ingredients to produce a cooked cereal mass; and blending a source of choline into the cooked cereal mass to produce a choline-fortified cereal mass used in the production of the ready-to-eat cereal.

The present invention also provides a composition comprising a ready-to-eat cereal. The ready-to-eat cereal includes a cereal grain and a nutritionally significant amount of choline.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a diagram of a method for making a choline-fortified, ready-to-eat cereal according to one embodiment of the present invention.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

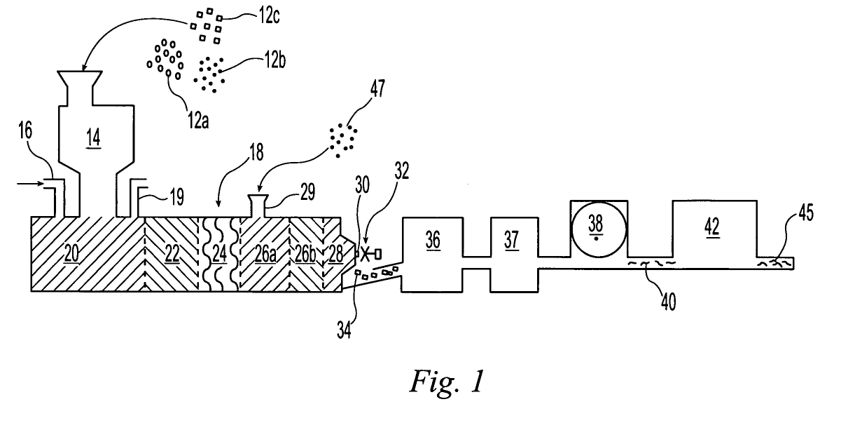

FIG. 1 illustrates, generally, a method of making an extruded, choline-fortified, ready-to-eat breakfast cereal according to one embodiment of the present invention. First, one or more dry cereal ingredients represented by 12a, 12b, and 12c are added to conditioning cylinder 14 where they are combined with water and conditioned to form a cereal ingredient blend. Dry cereal ingredients 12a, 12b, and/or 12c include any cereal grain known in the art, such as corn, wheat, rye, rice, oats, barley and mixtures thereof. Dry cereal ingredients 12a, 12b, and/or 12c may also include other ingredients, such as sugar, calcium carbonate, cocoa powder, milk powder, corn starch, brown sugar, salt, and/or any other ingredients known in the cereal art. Dry cereal ingredients 12a, 12b, and/or 12c may further include a vitamin and/or minerals, for example, Vitamin B₁, Vitamin C, Vitamin B₆, folic acid and Vitamin E.

The cereal ingredient blend is then deposited into feed zone 20 of multi-zone extruder 18, which may be a twin screw extruder. Any additional wet ingredients, such as malt syrup, corn syrup or any other wet ingredients used in cereals may be deposited into feed zone via inlet 16. Water or steam, if needed, is then added to the cereal ingredient blend in feed zone 20 via inlet 19. Alternatively, as is known in the art, steam and/or water may be added to the jacket of the extruder rather then through inlet 19. The resulting moistened cereal ingredient blend is mixed and cooked in cook/mixing zone 22 of extruder 18. The moistened cereal ingredient blend then moves to cook zone 24 where it is cooked further to produce a cereal mass, which is subsequently transported to post-cook mixing zones 26a and 26b.

Choline source 47 is then added to the cooked cereal mass in post-cook mixing zone 26a via vent 29. It should be understood that extruder 18 may include one or more post-cook mixing zones to facilitate the thorough mixing of the choline source into the cooked cereal mass. Choline source 47 and the cooked cereal mass is then mixed in post-cook mixing zones 26a, 26b, and the resulting choline-fortified cereal mass is moved to die zone 28, where it is compressed and, ultimately, extruded through die 30.

The source of choline can be any suitable source of choline, such as lecithin, and/or choline salts, such as choline chloride, and choline bitartrate. The term lecithin refers to any commercial lecithin. Commercial lecithin may comprise one or more phospholipids, glycolipids and/or sugars. Although it is contemplated that any lecithin may be used, 20%-90% phosphatidyl choline (PC) lecithin is considered a preferred source of choline, and 40% PC lecithin is demonstrated as a suitable source of choline in Example I. Choline source 47 may be added to vent 29 using a metered, air-assisted, screw conveyor (not shown) or other suitable metering equipment known in the art. In addition, a double vent or vacuum venting may be used as an alternative to vent 29 to prevent any undesired water absorption by the choline source. Because the choline is added after the cereal mass is cooked, the choline does not interfere with the cooking and an effectively elastic cereal mass is produced. In addition, post-cook mixing zones 26a and 26b are used to thoroughly mix the choline into the cooked cereal mass to produce an evenly fortified cereal mass.

The extruded, choline-fortified cereal mass is then cut into choline-fortified cereal pellets 34 by rotating blade/knife 32. Cereal pellets 34 are moved to rotating drum 36 where they are tumbled to flash off surface moisture. If necessary, the tumbled cereal pellets may then be conveyed to dryer 37, where they are dried to a moisture content suitable for flaking. Choline-fortified cereal pellets 34 are then conveyed to flaking rolls 38 where they are converted to choline-fortified cereal flakes 40. Finally, choline-fortified cereal flakes 40 are conveyed to toaster 42 where they are toasted to produce the final product, toasted choline-fortified, ready-to-eat cereal flakes 45.

While FIG. 1 illustrates the production of a choline-fortified flaked cereal, it should be understood that the present invention can be used to make other forms of choline-fortified cereal, such as choline-fortified puffed cereal or choline-fortified shredded cereal. Such cereal variations may be made by eliminating the drying, flaking and/or toasting steps; adjusting the blade speed and pellet size; and/or modifying the extruder parameters, such as extruder type, screw geometry, extruder length, screw speed, feed rate, and liquid injection rate. The process of the present invention may also be used to make choline-fortified foods other than breakfast cereal, such as snack chips and snack puffs.

In addition, the present invention may be incorporated into non-extrusion methods for making ready-to-eat breakfast cereals and snacks by adding the choline source after the cook and thoroughly mixing the choline into the cereal mass.

A composition of the present invention includes a ready-to-eat cereal including a cereal grain and a nutritionally-significant amount of choline. As discussed above the cereal grain can include any cereal grain known in the art, for example, corn, wheat, rye, rice, oats, barley and mixtures thereof. The nutritionally significant amount of choline may be at least about 5% of the Adequate Intake (AI) for choline per serving of the composition. Presently, the AI level is set at 550 mg per day for adult males, and 425 mg per day for adult females. In the case of adult males, this translates into about 0.092% weight of a 30 gram serving of the composition. To constitute a “good” to “excellent” source of choline, the composition comprises between about 0.183% and about 0.37% by weight of a 30 gram serving of the composition. It should be understood that these percentages may be modified in conjunction with changes in the designated levels of AI and/or changes in serving size.

The composition may also include sugar, malt syrup, cocoa powder, milk powder, brown sugar, corn starch, calcium carbonate, salt, corn syrup, a vitamin, a mineral, and/or any other ingredients known in the cereal art.

The invention will now be further described with reference to the following specific Examples. However, it will be understood that these Examples are merely illustrative and are not restrictive in nature.

### EXAMPLE I

Three Runs of corn-based, choline-fortified cereal flakes were produced according to the method generally described above and using the formulation and feed rates in Table 1. The dry cereal ingredients listed in Table 1, namely the corn cones (a fine, uniform corn meal), were added, along with water, to the conditioning cylinder. The corn cones were added to the conditioning cylinder at a rate of 80 kg/hr. The conditioning cylinder was operated at the parameters listed in Table 2. The conditioned cereal ingredient blend exiting the conditioning cylinder had the discharge temperature and moisture content listed in Table 2. The conditioned corn cones were added to the beginning of a five-head, twin-screw extruder operated under the parameters listed in Table 3. The syrup formulation of Table 1 was added to the beginning of the extruder at a rate of 16.5 kg/hr. The choline source was a soy-based, oil-free 40% PC lecithin, which contains about 5.4% choline.

The 40% PC lecithin was added to the post-cook mixing zone of the extruder at the rates listed in Table 1. More particularly, in Run 1 the lecithin was added at a rate of 3.2 kg/hr, which constituted approximately 3.4% of the total dry weight of the formula. In Run 3 the lecithin feed was increased to about 4.84 kg/hr, which constituted 5.0% of the total dry weight of the formula.

The extruded pellets leaving the extruder exhibited the discharge moisture and density listed in Table 3. A three-zone dryer/toaster was operated under the parameters listed in Table 4.

All three Runs produced acceptable choline fortified, ready-to-eat corn flakes that provided a good source or better of choline per serving; that is providing 10-15% of the Adequate Intake (AI) of choline (for adult males) per 30 g serving (0.183%-0.275% by weight of the choline fortified, ready-to-eat corn flakes). The choline fortified, ready-to-eat corn flakes of each Run were desirable in appearance being yellow in color and having a rough surface, acceptable curl, and some cupping. With respect to texture, the choline fortified, ready-to-eat corn flakes were acceptably hard, having good chew-down and moderately fracturable. The choline fortified, ready-to-eat corn flakes had good mouthfeel and were not gritty or slimy. The choline fortified, ready-to-eat corn flakes demonstrated an excellent bowl-life, maintaining good texture and mouthfeel for approximately three minutes after immersion in milk. With respect to flavor, the choline fortified, ready-to-eat corn flakes had a good flavor with no distinct lecithin flavor.

TABLE 1
FORMULATION & FEED RATES FOR
CHOLINE-FORTIFIED CEREAL FLAKES

| | Feed Rates | Feed Rates | Feed Rates |
|---|---|---|---|
| | (kg/hr) | (kg/hr) | (kg/hr) |
| | Run 1 | Run 2 | Run 3 |
| Dry Cereal Ingredients | | | |
| Corn Cones | 80 | 80 | 80 |
| Syrup Formulation | 16.5 | 16.5 | 16.5 |
| 45.16% Sugar | | | |
| 27.09% Water | | | |
| 13.75% Malt Syrup | | | |
| 14.00% Salt | | | |
| 40% PC Lecithin | 3.2 | 3.2 | 4.84 |
| (CENTROLEX ® FP-40) | | | |

TABLE 2
CONDITIONING CYLINDER PARAMETERS

| | Run 1 | Run 2 | Run 3 |
|---|---|---|---|
| Speed (rpm) | 150 | 150 | 150 |
| Steam Flow (kg/hr) | 11.6 | 11.6 | 11.6 |
| Water Flow (kg/hr) | 11.6 | 11.6 | 11.6 |
| Discharge Temp.(° C.) | 58 | 60 | 60 |
| Moisture Content (weight %) | 26.89 | 25.40 | 25.17 |

TABLE 3
EXTRUSION PARAMETERS

| | Run 1 | Run 2 | Run 3 |
|---|---|---|---|
| Shaft Speed (rpm) | 350 | 350 | 350 |
| Motor Load (%) | 21 | 20 | 20 |
| Steam Flow (kg/hr) | 4 | 4 | 4 |
| Water Flow (kg/hr) | 4 | 4 | 4 |
| First Head Temp. (° C.) | 90 | 90 | 89 |
| Second Head Temp. (° C.) | 110 | 110 | 110 |
| Third Head Temp. (° C.) | 112 | 108 | 112 |
| Fourth Head Temp. (° C.) | 88 | 88 | 88 |
| Fifth Head Temp. (° C.) | 80 | 81 | 80 |
| Lecithin Rate (kg/hr) | 3.2 | 3.2 | 4.84 |
| Head Pressure (kPa) | 2210 | 2060 | —* |
| Knife Drive Speed (rpm) | 318 | 268 | 265 |
| Pellet Discharge Moisture | 26.35 | 28.07 | 28.26 |
| (weight %) | | | |
| Pellet Discharge Density | 652 | 644 | 642 |
| (kg/m³) | | | |
| Duration of Extruder | —* | 50 | 50 |
| Run (mins) | | | |

*data unavailable

TABLE 4
DRYER/TOASTER PARAMETERS

| | Run 1 | Run 2 | Run 3 |
|---|---|---|---|
| Zone 1 Temp. (° C.) | 160 | 180 | 175 |
| Zone 2 Temp. (° C.) | 150 | 160 | 157 |
| Zone 3 Temp. (° C.) | 150 | 150 | 150 |
| Zone 1 Bed Air Velocity (m/min) | 100 | 99 | 99 |
| Zone 2 Bed Air Velocity (m/min) | 98 | 99 | 99 |
| Zone 2 Bed Air Velocity (m/min) | 99 | 99 | 99 |
| Bed Depth-First Pass (cm) | 0.9 | 0.8 | 0.9 |
| Bed-Depth-Second pass (cm) | 2.2 | 2.2 | 2.2 |

### EXAMPLE II

Three comparative Runs of corn-based, choline fortified cereal flakes were also produced using a method similar to Example I, except that the 40% PC lecithin was added to the beginning of the extruder, prior to the cook zone. The formulation used is listed in Table 5. All three Runs produced unacceptable choline fortified, extruded pellets. More specifically, the choline fortified, extruded pellets exiting the extruder lacked elasticity, which caused the pellets to shred at the flaking rolls, thereby making it difficult to produce flakes. The resulting flakes appeared raw in color and did not toast. With respect to flavor, the flakes imparted an off-flavor or lecithin flavor and were very dry tasting. The texture of the flakes was undesirable. Particularly, the flakes were too tender and demonstrated a poor bowl life.

TABLE 5
FORMULATION FOR COMPARATIVE
CHOLINE-FORTIFIED CEREAL FLAKES

```
Dry Cereal Ingredients
91.18% Yellow Corn Meal
Syrup Formulation
  5.80% Sugar
  2.00% Salt
  0.42% Calcium Carbonate
  0.34% Malt Syrup
  0.26% Corn Syrup
40% PC Lecithin (CENTROLEX ® FP-40)
Run 1: 1.7% on top of above formula
Run 2: 3.4% on top of above formula
Run 3: 6.8% adjusted against the Yellow Corn Meal
```

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for producing a choline-fortified, ready-to-eat cereal comprising the steps of:
cooking a blend of cereal ingredients by introducing the blend of cereal ingredients into a cook zone of an extruder to produce a cooked cereal mass; and
blending a source of choline into the cooked cereal mass in a mixing zone of the extruder to produce a choline-fortified cereal mass.

2. The method of claim 1 wherein the blend of cereal ingredients includes a cereal grain selected from the group consisting of corn, wheat, rye, rice, oats, barley and mixtures thereof.

3. The method of claim 2 wherein the blend of cereal ingredients further includes an ingredient selected from the group consisting of sugar, malt syrup, cocoa powder, milk powder, brown sugar, corn starch, calcium carbonate, salt, corn syrup, a vitamin, a mineral, and mixtures thereof.

4. The method of claim 1 further comprising the step of conditioning the blend of cereal ingredients in a conditioning cylinder prior to the step of cooking the cereal.

5. The method of claim 1 further comprising the steps of extruding the choline-fortified cereal mass; and cutting the extruded choline-fortified cereal mass into choline-fortified cereal pellets.

6. The method of claim 5 further comprising the step of drying the choline-fortified cereal pellets.

7. The method of claim 5 further comprising the step of flaking the choline-fortified cereal pellets to produce choline-fortified cereal flakes.

8. The method of claim 5 further comprising the step of toasting the choline-fortified cereal flakes to produce toasted choline-fortified cereal flakes found in the choline-fortified, ready-to-eat cereal.

9. The method of claim 5 further comprising the step of puffing the cereal pellets to produce choline-fortified cereal puffs found in the choline-fortified, ready-to-eat cereal.

10. The method of claim 1 wherein the source of choline is lecithin.

11. The method of claim 10 wherein said step of blending a source of choline into the cooked cereal mass includes blending lecithin into the cooked cereal mass in an amount to supply at least 5% of the Adequate Intake (AI) of choline per serving of the choline-fortified, ready-to-eat cereal.

12. The method of claim 1 wherein the source of choline is a choline salt.

13. The method of claim 12 wherein said step of blending a source of choline into the cooked cereal mass includes blending a choline salt into the cooked cereal mass in an amount to supply at least 5% of the Adequate Intake (AI) of choline per serving of the choline-fortified, ready-to-eat cereal.

14. A choline-fortified ready-to-eat cereal produced according to the method of claim 1.

15. A composition comprising a ready-to-eat cereal, said ready-to-eat cereal comprising a cereal grain and a nutritionally significant amount of choline.

16. The composition of claim 15 wherein said nutritionally significant amount of choline is an amount supplying at least 5% of the AI of choline per serving of the composition.

17. The composition of claim 15 wherein said cereal grain is selected from the group consisting of corn, wheat, rye, rice, oats, barley and mixtures thereof.

18. The composition of claim 15 wherein said choline is in the form of lecithin.

19. The composition of claim 18 wherein said nutritionally significant amount of choline is an amount of lecithin supplying at least 5% of the AI of choline per serving of the composition.

20. The method of claim 15 wherein the source of choline is a choline salt.

21. The composition of claim 15 wherein said ready-to-eat cereal is a flaked ready-to-eat cereal.

22. The composition of claim 15 wherein said ready-to-eat cereal is a puffed ready-to-eat cereal.

23. The composition of claim 15 further comprising an ingredient selected from the group consisting of sugar, malt syrup, cocoa powder, milk powder, brown sugar, corn starch, calcium carbonate, salt, corn syrup, a vitamin, a mineral, and mixtures thereof.

24. A method for producing a choline-fortified, ready-to-eat cereal comprising the steps of:
cooking a blend of cereal ingredients to produce a cooked cereal mass; and
blending a source of choline into the cooked cereal mass to produce a choline-fortified cereal mass.

25. The method of claim 24 wherein the blend of cereal ingredients includes a cereal grain selected from the group consisting of corn, wheat, rye, rice, oats, barley and mixtures thereof.

26. The method of claim 25 wherein the blend of cereal ingredients further includes an ingredient selected from the group consisting of sugar, malt syrup, cocoa powder, milk powder, brown sugar, corn starch, calcium carbonate, salt, corn syrup, a vitamin, a mineral, and mixtures thereof.

27. The method of claim 24 further comprising the step of converting the choline-fortified cereal mass into choline-fortified cereal flakes.

28. The method of claim 24 further comprising the step of converting the choline-fortified cereal mass into choline-fortified cereal puffs.

29. The method of claim 27 further comprising the step of toasting the choline-fortified cereal flakes to produce toasted choline-fortified cereal flakes found in the choline-fortified, ready-to-eat cereal.

30. The method of claim 24 wherein the source of choline is lecithin.

31. The method of claim 30 wherein said step of blending a source of choline into the cooked cereal mass includes blending lecithin into the cooked cereal mass in an amount to supply at least 5% of the Adequate Intake (AI) of choline per serving of the choline-fortified, ready-to-eat cereal.

32. The method of claim 24 wherein the source of choline is a choline salt.

33. The method of claim 32 wherein said step of blending a source of choline into the cooked cereal mass includes blending a choline salt into the cooked cereal mass in an amount to supply at least 5% of the Adequate Intake (AI) of choline per serving of the choline-fortified, ready-to-eat cereal.

34. A choline-fortified ready-to-eat cereal produced according to the method of claim 24.
